(19) United States
(12) Patent Application Publication
(10) Pub. No.: US 2016/0353880 A1
(43) Pub. Date: Dec. 8, 2016

(54) System And Method For Sensing Obstructions Of Sensors Used With An Adjustable Height Work Desk

(71) Applicant: TOME, INC., Royal Oak, MI (US)

(72) Inventors: Jacob R. SIGAL, Ferndale, MI (US); Massimo BALDINI, Beverly Hills, MI (US); Philip J. DANNE, Royal Oak, MI (US)

(21) Appl. No.: 15/171,864

(22) Filed: Jun. 2, 2016

Related U.S. Application Data
(60) Provisional application No. 62/170,495, filed on Jun. 3, 2015.

(51) Int. Cl. A47B 21/02; G01D 21/02; A47B 9/00

(52) U.S. Cl. CPC A47B 21/02; A47B 9/00; G01D 21/02

(57) ABSTRACT

The present disclosure relates to a system for monitoring use of a work structure at which a user is present, and detecting if any one of one or more sensors of the system are obstructed. The system may have a work structure at which a user may perform a task. A first sensor may be used for detecting a first characteristic of use of the work structure and generating a first signal in accordance therewith. A second sensor may be used for detecting a second characteristic of use of the work structure and generating a second signal in accordance therewith. A computer based processing and monitoring subsystem may be used for analyzing the first and second signals and determining if one or the other of the first and second sensors is at least one of obstructed or malfunctioning.

### CROSS-REFERENCE TO RELATED APPLICATIONS

This application claims the benefit of U.S. Provisional Application No. 62/170,495, filed on Jun. 3, 2015. The entire disclosure of the above application is incorporated herein by reference.

### FIELD

The present disclosure relates to furniture such as office desks and work tables, and more particularly to a system involving an adjustable height work desk which includes various sensor subsystems and processing algorithms for accurately monitoring the height of the work desk and detecting, in real time, blockages of the sensors used with the work desk, and providing a real time alert to the user of the sensor blockage condition.

### BACKGROUND

The statements in this section merely provide background information related to the present disclosure and may not constitute prior art.

There is a growing interest in promoting health and well-being in the office environment. This extends to encouraging workers to stand at their desks to perform various tasks such as participating in teleconferences, webinars, video conferences, etc. Business entities and their employers are increasingly realizing the benefit of standing while working. Many tasks, such as those mentioned above, as well as managing email, creating or managing spreadsheets, drafting documents, etc., can also be performed with relative ease while standing. Working while standing can burn significantly more calories than working while sitting. Some estimates provide that standing at a work desk and performing routine work tasks (e.g., talking on the telephone, managing email, drafting documents, etc.) can burn up to 50 calories or more per hour over a person would burn while performing the same activities in a seated position. Sitting for prolonged periods can potentially also aggravate existing back problems, and possibly even cause some back issues depending on the sitting posture of the individual.

To facilitate working while standing some manufacturers have introduced work desks that can be raised and lowered by the individual. Some of these adjustable height desks are motorized and use an electric motor to raise and lower the desk, while others employ some type of counterweight mechanism and are manually lifted and lowered by the user to the desired positions with the help of the counterweight system. In either case, there is no means to inform the user when the desk is at exactly the same height. Some desk systems rely on markings somewhere on a frame portion of the desk to indicate different heights, but still the user is required to carefully watch and adjust the position of the desk to an approximate, desired position each and every time the user changes the desk height. This applies for both raising the lowering the desk.

Accordingly, it would be highly desirable to provide some type of system that allows the user to precisely set and store one or more preferred desk heights. Such a system would enable the user to set a precise height for the desk when the desk is in a lowered position as well as when the desk is in a raised position. It would also be desirable if the system enables multiple users to store preferred heights for the same desk, and the system is able to recognize which user is using the desk system and automatically apply the preferred height settings for a specific user through one or easily accessible user controls. It would also be desirable if the system is able to receive ergonomic information or data based on actual physical measurements of physical biometric traits of the individual, by which the height of the desk system can be set.

Still further, it would be highly desirable to provide a desk system that has the intelligence to reliably determine when a desk surface is at its predetermined maximum elevated height, as well as when the desk surface is at its predetermined minimum height, or at some intermediate height. In this manner, the accumulated time that a user uses the desk system while it is at its elevated and lowered positions can be reliably tracked. It would also be highly desirable to provide the system with intelligence that enables the system to detect when some external object is present in a vicinity of the desk system, such as underneath a desk surface or on top of the desk surface, which could interfere with the sensing systems used by the desk system to detect its present height or the presence of an individual seated (or standing) in front of the desk system. Such a feature is expected to be particularly valuable because of the importance of keeping accurate running totals of standing/sitting time for various individuals. If the accuracy of the sensing subsystem of a desk system can be comprised simply by a user setting a backpack under or on top of a desk system, then the collected usage data for the user (or users) of the desk system would be much less valuable to an entity which owns and/or operates the desk systems, and which is making use of the collected usage data.

Still further, a desk system which tracks real time usage of users (e.g., accumulated standing or sitting time), and which is able to detect, in real time, when a sensor(s) used with the desk system may be blocked or otherwise not providing a valid signal, and which can immediately generate an alert to a user to check for a blocked sensor, would be highly valuable to ensuring that the usage data collected or reported from the desk system is accurate and valid usage data.

### SUMMARY

This section provides a general summary of the disclosure, and is not a comprehensive disclosure of its full scope or all of its features.

In one aspect the present disclosure relates to a system for monitoring use of a work structure at which a user is present, and detecting if any one of one or more sensors of the system are obstructed. The system may comprise a work structure at which a user may perform a task. A first sensor may be included for detecting a first characteristic of use of the work structure and generating a first signal in accordance therewith. A second sensor may be included for detecting a second characteristic of use of the work structure and generating a second signal in accordance therewith. A computer based processing and monitoring subsystem may be included for analyzing the first and second signals and determining if one or the other of the first and second sensors is at least one of obstructed or malfunctioning.

In another aspect the present disclosure relates to a work desk at which a user may perform work in at least one of a standing or seated orientation. The work desk may comprise an elevationally positionable desk surface. A first sensor may be included for detecting a first characteristic of use of the work desk associated with movement of the desk surface and generating a first signal in accordance therewith. A second sensor may be used for detecting a second characteristic of use of the work structure associated with movement of the desk surface, and generating a second signal in accordance therewith. A computer based processing and monitoring subsystem may be included for analyzing the first and second signals and determining if one or the other of the first and second sensors is at least one of obstructed or malfunctioning.

In still another aspect the present disclosure relates to a method for monitoring use of a work structure at which a user is present, and detecting if any one of one or more sensors associated with the work structure are obstructed. The method may comprise a plurality of operations including providing a work structure at which a user may perform a task, and using a first sensor for detecting a first characteristic of use of the work structure, and generating a first signal in accordance therewith. The method may further include using a second sensor for detecting a second characteristic of use of the work structure and generating a second signal in accordance therewith. The method may still further include using a computer based processing and monitoring subsystem for analyzing the first and second signals and determining if one or the other of the first and second sensors is at least one of obstructed or malfunctioning.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level illustration of one embodiment of a system in accordance with the present disclosure for enabling quick, accurate adjustments of the height of a work desk;

FIG. 2 is a high level block diagram of one embodiment of the height control system shown in FIG. 1;

FIGS. 3A and 3B represent a flowchart of various operations that may be performed by the system during use;

FIG. 4 shows another embodiment of a desk system in accordance with the present disclosure with various sensing subsystems and signal processing subsystems configured to interpret various obtained sensor data to detect if one or more of the sensor systems may be blocked, and to generate an alert notification to the user (e.g., email, text message, etc.);

FIG. 5 shows examples of waveform characteristics that may be analyzed by the signal processing subsystems and algorithms of the present disclosure, to detect a potentially blocked or malfunctioning sensor system;

FIG. 6 shows another waveform which illustrates a spurious signal that the signal processing subsystems may interpret is a condition where a sensor may be at least partially blocked, or which indicate some type of obstacle placed to interfere with a sensing beam of one of the sensors; and

FIG. 7 is a flowchart illustrating one example of various operations that may be performed by the system of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

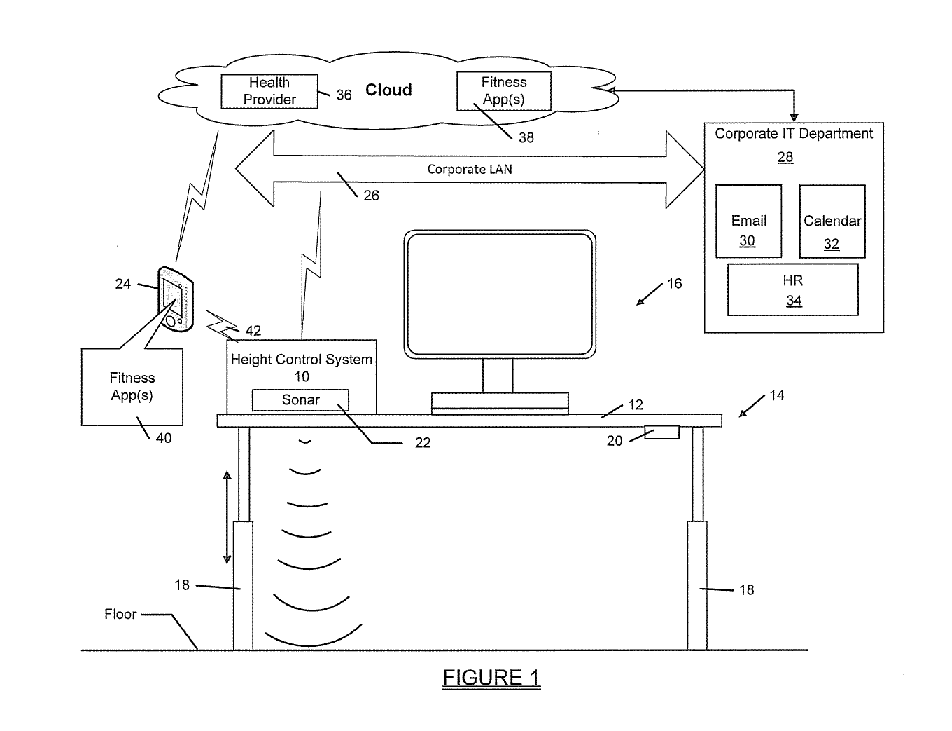

Referring to FIG. 1, there is shown a height adjust system 10 in accordance with one embodiment of the present disclosure. The height adjust system 10 (hereinafter simply “system 10”) may be positioned on a desk surface 12 of a desk 14, or possibly underneath the desk surface 12 or alongside the desk surface 12. It is only important that the system 10 be mounted so that it moves with the desk surface 12. Alternatively, it is possible that a sensor component of the system 10, to be described momentarily, may be physically attached somewhere to the desk surface 12, while the remainder of the system 10 is positioned on a stationary panel or leg portion of the desk 14, or possibly on the ground adjacent the desk 14.

The desk surface 12, in one embodiment, is used to support a computer system 16 or other form of personal electronic device that the user needs to use. Accordingly, the desk 14 may be used to support a laptop, a table or any other type of computing device and is not limited to use with a desktop computer. However, as will be appreciated from the following discussion, the system 10 is not limited to use in office or home environments with computing devices. The system 10 can be used in connection with assembly tables or any other desk/table like structure used in a factory setting where setting two or more user adjustable heights would enhance the convenience, productivity and/or comfort to the user while performing the same tasks or performing different tasks at the desk/table like structure. It is also possible that the system 10 could be employed in connection with shelving systems used in warehouses to store goods that employees need to access frequently.

The desk 14 may be constructed to have a plurality of legs 18 that have a telescoping construction, along with a user control 20 that releases a locking mechanism and allows the user to manually raise and lower the desk surface 12. Alternatively, the desk surface 12 may be raised and lowered by an electric motor, with control 20 allowing up or down travel of the desk surface 12. The system 10 is not limited to use with any particular type of desk (i.e., manually adjustable height or motor driven height control). It is a principal feature of the system 10 that it can be used with desks having either a manually adjustable height or a motor driven height adjusting system. It is also a significant feature of the system 10 that it can be easily retrofitted to either style of desk with no modifications being required to the desk itself. And it will be appreciated that the system 10 could be used with an independent adjustable-height platform, that rests on an otherwise fixed height desk. In such an embodiment the system 10 would be sensing the height from either the fixed upper surface of the desk, to a riser or platform that is raisable and lowerable by the user, or alternatively from the floor surface to the riser or platform.

The system 10 makes use of a sonar sensor 22, in one embodiment a sonar sensor 22, for real time sensing of the height of the desk surface 12 relative to a floor on which the desk is supported, or alternatively relative to a fixed height desk surface on which is supported an adjustable height platform or riser. For the purpose of discussion, the example where an adjustable height desk will be used. The system 10 may communicate via a short range wireless link, such as a Bluetooth® protocol signal link, a ZigBee® protocol wireless link, or any other suitable form of wireless near field communication link, with the user's smartphone 24. The system 10 may also communicate via a short range wireless link (e.g., Bluetooth® protocol link, ZigBee® protocol link, etc.) with a corporate LAN 26. A corporate IT department 28 where servers are present for managing the email accounts 30 and calendars 32. A human resources (HR) department 34 may be in communication with the email accounts 30 and the calendars 32. The Corporate IT department may also be in communication with one or more cloud-based services, for example a health provider 36 and/or one or more personal or corporate wellness fitness applications 38.

The user's smartphone 24 may also optionally contain one or more fitness applications 40 stored thereon, or otherwise may access the one or more cloud-based fitness applications 38. The smartphone 24 also may be used to identify the user to the system 10 via the short range wireless signal link 42 (e.g., Bluetooth® protocol, ZigBee® protocol link or other type of link) established between the smartphone 24 and the system 10.

The system 10 allows the user to quickly raise and lower the desk surface 12, either manually or with the assistance of a motor driven lift mechanism, to a precise, previously set height, and to provide the user with a signal when the desk surface is at the previously set height. The system 10 also enables multiple users who have their own preset heights saved in the system 10 to use the system 10 without the need for entering an identification parameter. The system 10 may automatically identify the user based on the wireless connection with the user's smartphone, and then may automatically notify the user when his/her preset desk height is reached as the user raises or lowers the desk surface 12. This facilitates highly convenient use of a desk that needs to be shared by two or more individuals, and where the different individual will want to use the desk 14 in both standing and seated positions.

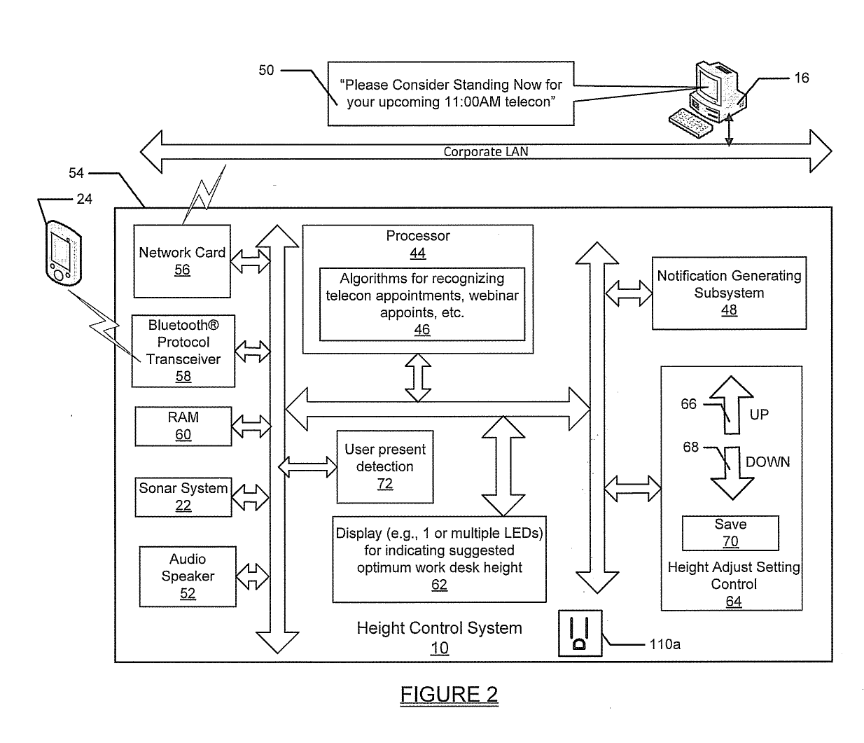

Referring to FIG. 2 the system 10 one example of the construction of the system 10 is shown. AC power may be provided to the system via a conventional AC outlet jack 10a. DC power from a suitable battery could alternatively be used to power the components of the system 10. In addition to the sensor 22, which is illustrated in this example as a sonar sensor, the system 10 may include a processor 44 with suitable on-board or off-board memory for storing algorithms 46 for recognizing key words on the user's calendar. The key words may be, for example, “webinar”, “teleconference”, “videoconference”, “WebEx”, etc., or any other word that indicates an activity that may potentially be performed easily while standing. The processor 44 may use the results of the algorithms to detect and suggest to the user when standing would be possible for an upcoming appointment, and to provide a notification 50 of such via a notification generating subsystem 48. The notification may be pushed on to the user's display system associated with his/her computer system 16. Alternatively, a pre-recorded message may be played through an audio speaker 52 housed within a cabinet or housing 54 of the system 10.

The system 10 may also have a network card 56 for communicating with the corporate LAN 26, a short range, wireless protocol transceiver 58 (e.g., Bluetooth protocol transceiver, ZigBee protocol transceiver, etc.), a random access memory (RAM) 60 for storing different preset heights by different users, and a display system 62 (LED or LCD) for indicating to the user when the desk surface 12 is at a predetermined height during a raising or lowering action of the desk surface. In one embodiment a plurality of LEDs may be used, or alternatively a multi-colored LED, which provides different optical signals to the user (e.g., green light, yellow light, red light) as the desk surface 12 is being raised or lowered to indicate to the user how close the user is to his/her preset height. Providing a green optical signal may indicate to the user that the desk surface is at exactly the preset height, while a yellow light may signal to the user that the desk surface 12 height is within an inch or two of the present height, and the red light may signal that the desk height is well outside of its preset height. These height indicating signals may be provided when the desk surface is being raised or lowered, to thus indicate to the user when the desk surface 12 reaches a preset elevated height or when it reaches a preset lowered height.

A height adjust setting control 64 may be included in the system 10 for enabling the user to save a lowered and elevated heights for the desk surface 12. An “UP” control may be pressed by the user after the desk surface 12 is positioned at a desired height by the user, and then a “SAVE” control 70 may be pressed which saves the elevated height in memory. Alternatively, these different height settings could be saved using a suitable software application running on the computing device which is present on the desk surface 12. Such a modification would require the system 10 to output signals indicative of saved height positions to the computing device. It is also possible that the height settings could be communicated to and saved on a personal electronic device of the user such as a smartphone or computing tablet, using a wireless near field communications link (e.g., Bluetooth® protocol or ZigBee® protocol wireless link). Such a modification would require suitable height position signals to be sent from the system 10 to the user's smartphone or tablet, and then recalled by the system 10 to aid the system 10 in determining the saved height positions for a specific user, provided the user's smartphone or tablet is proximity to the system 10, with the required software application running on the smartphone or tablet.

During the process of raising the desk surface 12 to the desired height, the sonar sensor 22 will be providing signals to the processor 44 which enable the processor 44 to highly accurately determine the height of the desk surface 12. When the user presses the SAVE control 70 after pressing the UP control 66, the processor stores this height as a preset elevated height for the desk surface 12 in the RAM 60. Optionally, an identification of the user may be stored as well by using the wireless link with the user's smartphone which identifies the user to the system 10. When the user is lowering the desk surface 12 the sonar sensor 22 is likewise monitoring the real time height of the desk surface and sending signals to the processor 44 which enable the processor to determine the real time height of the desk surface 12. When the user has the desk surface lowered to an optimum height, the user may press the “DOWN” control 68 and then the SAVE control 70, which saves the lowered position of the desk surface 12 in the RAM 60. Thereafter, if the user wants to raise the desk surface 12 from its preset lowered position to the preset elevated position, the user would simply begin lifting the desk surface (if the desk surface is manually adjustable) or engage the appropriate control to cause a motor to begin lifting the desk surface. The display system 62 will provide an optical signal to the user as the user gets close to the preset elevated height (e.g., yellow LED being illuminated), and a different optical signal (e.g., green LED being lit) will be provided once the height is at exactly the preset elevated height. Optionally or in addition to the optical signals, a tone may be provided from the audio speaker 52 when the elevated preset height is reached. The same operations may be performed by the system 10 when the desk surface 12 is lowered.

It will be noticed that the user is not required to enter any commands to the system 10 once the lowered and elevated height presets are saved in the system 10. Whenever the user needs to raise or lower the desk surface 12 the user simply starts raising or lowering the desk surface and the system 10 will detect whether the action is a raising or lowering action and notify the user when the proper preset has been reached. Thus, the desk surface 12 can be repeatedly moved between lowered and elevated heights by the user and it will always be repositioned at exactly the appropriate preset height (either for elevated use or lowered position use).

The height adjust setting control 64 may also be modified with the addition of a keyboard which would enable a user to enter a code identifying him/her to the system 10. The processor 44 would store such codes along with the specific presets saved by the user. This option would enable multiple users to use the system without the need for some external means of identifying users to the system 10 (e.g., without a smartphone and its Bluetooth® protocol or ZigBee® protocol wireless link). Once the user has entered his/her code, the system 10 would thereafter use the appropriate presets for that particular user.

Another feature that the system 10 provides is a user detection system 72 that detects the presence of a user at the work desk 14. The user detection system may be either an optical or sonar based subsystem that continuously monitors when the user is present at the work desk, regardless if the user is standing or seated. The user detection system 72 generates appropriate signals that the processor 44 uses to determine if the user is present at the desk surface. During those periods where the user is standing, the processor 44 may transmit information either to the Corporate IT department 28 or to one or more cloud-based subsystems, for example health provider 36 in FIG. 1, which allows the standing time of the user to be logged. This information may be used by the Corporate IT department 28 and/or the health provider, or any other connected entity, for purposes of promoting and encouraging the use of the desk 14 in the standing orientation. Such promoting and encouraging may be done through gamification programs implemented by the HR department 34 and/or the health provider 36, or any other entity. But in either event, the user present detection system 72 enables the system 10 to detect those times that the user is actually at the work desk 14 and working while in a standing position.

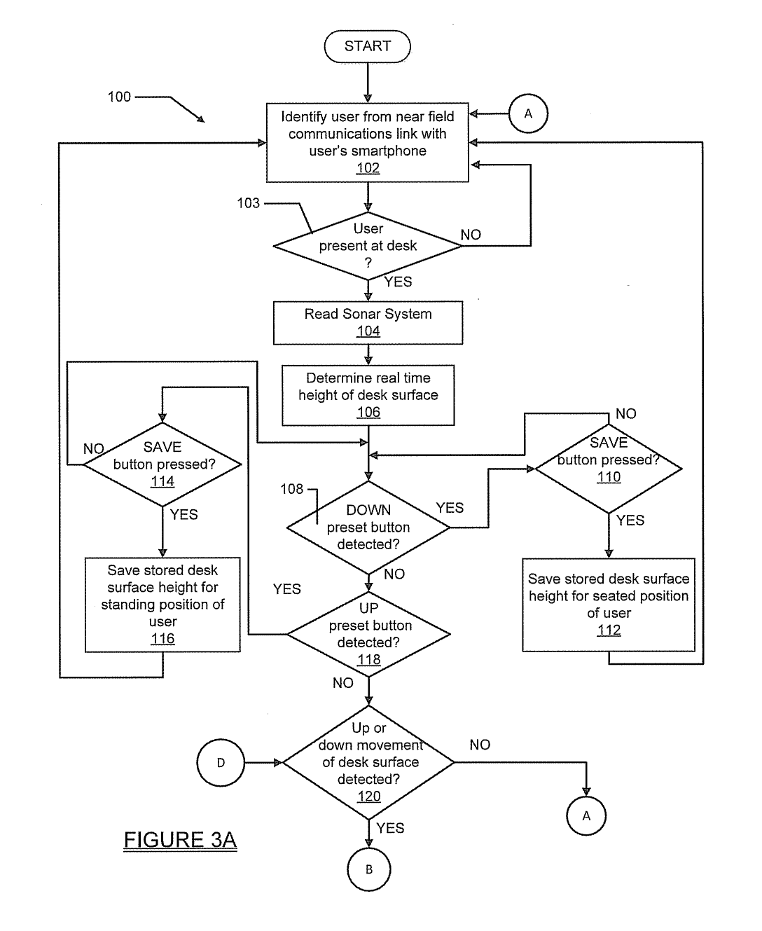

Referring to FIGS. 3A and 3B, a flowchart 100 illustrates various operations that may be performed by the system 100 during use. At operation 102 the system 10 may initially identify the user to the system 10. This may be done by use of the near field communications link (e.g., Bluetooth® protocol or ZigBee® protocol link) with the user's smartphone 24, or possibly by identifying a tablet that the user is carries with him/her.

At operation 103 the system 10 makes a determination by use of the “user present” detection system 72 if the user is actually present at the desk 14. If no user is detected, then operation 102 may be re-performed.

At operation 104 the processor 44 reads or obtains signals from the sonar sensor 22. At operation 106 the processor 44 determines the real time height of the desk surface 12. At operation 108 a check is made if the DOWN preset control 68 has been pressed, indicating that the user is attempting to program a lowered desk surface height. If the check at operation 108 is produces a “Yes” answer, then the processor 44 checks to determine if the SAVE control 70 has been pressed, as indicated at operation 110, which indicates that a lowered preset desk position is being entered by the user. If the SAVE control 70 has been pressed at operation 110, then the processor 44 saves the lowered desk height for the user in the RAM 60. Similarly, if the test at operation 118 indicates that the UP preset control 66 has been pressed, then the system 10 checks to determine if the user has pressed the SAVE control 70, as indicated at operation 114. If so, then the current elevated height of the desk surface 12 is saved by the processor 44 in the RAM 60, as indicated at operation 116. The saved lowered and elevated desk surface presets may be associated with the particular user, provided the system 10 is constructed to accommodate saving presets for multiple different users.

At operation 120, the system 10 is continually checking, in real time, to determine if the desk surface is being moved from one of its elevated or lowered preset positions. If the check at operation 120 indicates that the desk surface 12 is being moved, then at operation 122 (FIG. 3B) the system 10 determines whether the desk surface 12 is at its elevated or lowered preset height, based on the direction of movement that is detected. By this it is meant that the system 10 detects when the movement of the desk surface 12 is upwardly, and will look for the elevated height preset, and when the movement is detected as being a lowering movement, the system 10 detects when the lowered height preset is reached. At operation 124 the system 10 uses the display system 62 to provide optical signals to the user, and optionally the speaker 52 to provide an audible signal as well, to inform the user when the elevated or lowered height preset has been reached. If the system 10 detects that the desk surface 12 has been lowered from its elevated position, the system 10 may then record the previous number of minutes that the desk surface was being used in its elevated position and/or report this usage to the HR department, the user's fitness application(s) and/or a health provider, as indicated at operation 126. If the system 10 detects that the desk surface 12 has just been raised to its elevated position, the system 10 begins logging the minutes that the desk surface 12 is at its elevated position while the user is detected as being present at the desk 14. It will be appreciated that the foregoing operations represent merely one example of how the system 10 may operate, and those skilled in the art will recognize the possibility of various modifications, without departing from the spirit and scope of the present disclosure.

As noted above, the system 10 is easily retrofittable to virtually any existing work desk without modification to the work desk. The sonar sensor 22 may be located within the housing 54, which provides a single component that is placed on top of or mounted underneath the desk surface 12. Alternatively, the sonar sensor 22 may be a stand-alone, independently mountable component which is linked to the remainder of the system 10 via a suitable electrical cable. This would allow the sonar sensor 22 to be mounted, for example, to the lower surface of the desk surface 12, and the remainder of the system 10 to be positioned on the floor next to the desk 14 or attached to the side of the desk 14. In either implementation, the system 10 can easily be moved from one desk to another if the need arises.

And while the system 10 has been described in connection with a desk 14, it will be appreciated that the system 10 is expected to find use with any type of table that can be raised or lowered to different heights to permit different work operations. As such, the system 10 may be used with assembly tables in a factory environment where different types of assembly operations on goods may require that a table top of an assembly table be positioned at different heights. If the system 10 includes the modification of allowing a user ID code to be entered, then the system 10 would allow the same desk height to be set for different users. This would also enable different users who have to periodically use a given table surface in a manufacturing or assembly environment to quickly and easily set the height of the table surface to a previously saved height. The system 10 may also find potential use in the food service industry, such as in connection with table surfaces used to prepare sandwiches, where different employees having significantly different heights may need to alternately use the same work surface throughout a given day. The system 10 may eliminate the need to have two or more fixed assembly tables at different heights for different assembly operations, or possibly for different users, since the system 10 allows different heights to be set for a given user, and is may be configured to allow for saved, custom height settings for different users.

And while the system 10 has been described as enabling the setting of either a raised height or lowered height (i.e., two different heights), a modification could easily be implemented to enable the system 10 to record three or more heights for a desk or assembly table for a given user/assembly technician. The use of three or more preset heights is likely to be more advantageous in a manufacturing environment, but nevertheless could easily be implemented by simply providing additional present buttons, similar to the UP control 66 and the DOWN control 68.

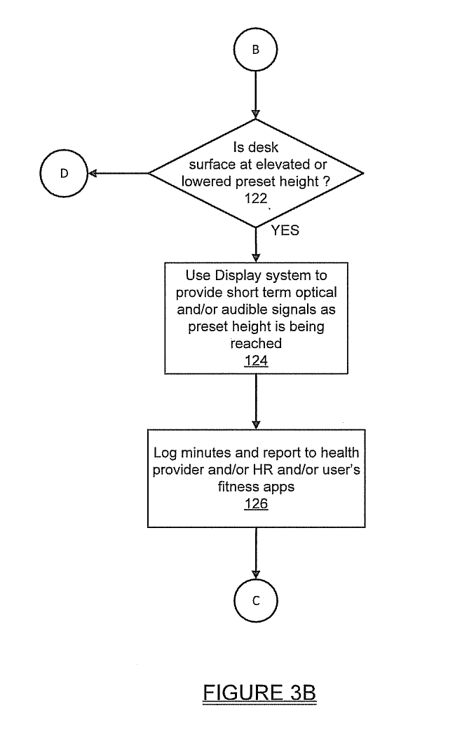

Referring now to FIG. 4, a desk system 200 is shown which incorporates a vertically adjustable work desk system 202 and a signal processing/monitoring subsystem 204 (hereinafter simply “signal processing subsystem 204”). While the signal processing subsystem 204 is shown as a cloud-based component, it will be appreciated that the signal processing subsystem 204 could instead by integrated into the work desk system 202 itself or located at an IT department work area near the work desk system 202. Thus, the present disclosure is not limited to having the signal processing subsystem 204 located at any particular location.

The work desk system 202 may be similar or virtually identical in construction to the work desk used in connection with the system 10. In this regard, the work desk system 202 may include a plurality of different types of sensing subsystems which are secured to or positioned on various areas of a work desk 206. The work desk 206 is adjustably positionable such that a desk surface 208 may be raised and lowered between a predetermined minimum height and a predetermined maximum height. The sensing subsystems used may include one or more of an acoustic sensor 210, an infrared (“IR”) motion sensor 212, an accelerometer 214, a sonar subsystem 216, a plurality of photoelectric sensing subsystems 218a and 218b, and a pressure sensitive floor mat 219, just to name a few of the different types of sensing systems that may be included in the system 200. It is anticipated, however, that with most implementations of the system 200, the sonar subsystem 216, the infrared motion sensor 212 and the accelerometer 214 will be particularly useful and desirable for detecting the majority of situations, during normal use of the desk system 204, where a blocked sensor condition could arise and thus produce spurious sensor signals that would otherwise not be capable of being interpreted by the signal processing/monitoring subsystem 204. The functions of these particular sensing subsystem 212-216 will be discussed in greater detail in the following paragraphs.

The system 200 also may include a sensor data collection module 220 which collects the sensor data obtained by each of the sensor subsystems 210-219, and wirelessly transmits the data to the signal processing/monitoring subsystem 202. Transmission may be either via a local area network, which communications with a wide area network such as the Internet, or possibly by a cellular network. Optionally, the sensor data collection module 220 may include a low power, short range wireless radio system in accordance with the Bluetooth® wireless communications protocol or the ZigBee® wireless communications protocol, or any other suitable protocol, so that a wireless link is established with some other like-configured communications device. Typically a personal electronic device 222 of the user, such as a smartphone or computing tablet, will also be present at the work desk system 202, which provides a means to receive wireless notifications from the signal processing/monitoring subsystem 204 via a commonly used Bluetooth® wireless protocol or ZigBee® wireless protocol communications link.

The signal processing/monitoring subsystem 204 in this example is shown as a cloud-based subsystem, although as mentioned previously, it need not be cloud-based. In this example the signal processing/monitoring subsystem 204 may include a notification/alert subsystem 224, a processing subsystem 225 running one or more sensor signal processing and interpretation algorithms 226, and a desk usage logging database 228. The notification/alert subsystem 224 may be used to transmit notification messages to the user's PED 222 and/or to a computer system 230 positioned on the work desk 206, and/or possibly to a corporate IT department 232, if a blocked or spurious sensor signal is detected from any of the sensor subsystems 210-219. The desk usage logging database 228 collects usage data pertaining to the accumulated time periods that the user has used the work desk system 202 while in the seated and standing positions. This information may be kept for a plurality of users of the work desk system 202 provided there is some identification or log-in procedure that the users use when they begin working at the work desk system 202. If the work desk system 202 is dedicated to one specific user, then no log-in procedure may be needed. In this instance the system 200 assumes that whenever an individual is detected as being present at the work desk system 202, that it will be the same individual using the work desk system in every instance. Collected usage information may be transmitted to the corporate IT department 232, and/or directly to the users PED 222, and/or possibly even to a remotely located third party such as a health/wellness provider, and/or to one or more remotely located (e.g., cloud-based) fitness applications that the user has established. The collected usage data may be provided in any convenient format, and possibly broken down in a variety of ways such as by day, week, month or year. Other data indicating when the work desk system 202 is not in use (i.e., no user detected as being present at the desk system 202) may also be provided. Total usage time during each day, week, month or year could be logged and provided if a plurality of different users are sharing the work desk system 202 each day.

The various sensor subsystems 210-219 may function in various ways to help detect either when a person is present and working at the work desk system 202, or when no individual is present at the work desk system 202. The various sensor subsystems 210-219 may be monitored and their respective signals analyzed by the sensor signal interpretation algorithms 226 to determine, in real time, if one or more of the sensor subsystems 210-219 is blocked or otherwise providing a signal which is outside the bounds of a predetermined signal range, wherein the predetermined signal range indicates normal operating conditions.

The acoustic sensor 210 may monitor sounds in the immediate vicinity of the work desk system 202, for example key actuations on a keyboard, a human voice in the immediate vicinity of the desk system 200 (e.g., within 3-4 feet of the work desk system 202), or any other audible sound which might help to indicate that an individual is present at the work desk system 200. These signals from the acoustic sensor 210 may be used together with one or more other sensed signals from other ones of the sensor subsystems 212-219 to verify that the sounds coming from the vicinity of the work desk system 202 are in fact sounds associated with a person working at the work desk system. For example, when the infrared motion sensor 212 is detecting that an individual is present in front of the work desk 206, and the audible sounds picked up by the acoustic sensor 210 suggest the same fact, then a reliable determination can be made that, in fact, an individual is actually present at the work desk system 202. In this regard it is preferred that the acoustic sensor 210 have a directional pickup pattern so that it can be “tuned”, when it is physically secured to the work desk 206, to “look” in a specific direction for sounds, and more preferably to look toward the area where the individual would be seated or standing, or possibly toward the keyboard of the computer system 230.

The sonar subsystem 216 is expected to be an important sensing mechanism for sensing the height of the desk surface 208, as described in connection with the system 10 in FIG. 1. The sonar subsystem 216 senses a real time height of the desk surface 208 using reflected sound waves. The sonar subsystem 216 may periodically emit acoustic pulses, for example, every 10 ms-500 ms (or at any other suitable frequency), to determine the real time height of the desk surface. The accelerometer 214 may be used in connection with the sonar subsystem 216 to determine if the desk surface 208 is being moved while desk height sensing is occurring. In this instance, the signal processing/monitoring subsystem 226 may analyze both signals from subsystems 214 and 216 and determine that what appears to be a spurious signal from the sonar subsystem 216 is not the result of any blockage or physical item affecting operation of the sonar subsystem 216, but rather simply the result of movement of the desk surface 208, possibly by the user adjusting the height of the desk surface or moving it from its fully lowered position to its fully raised position. This determination may be further verified by looking at the signal from the infrared motion sensor 212. If the infrared motion sensor 212 is indicating that an individual is present in front of the work desk 206, that fact would further verify that a height adjustment is being made. Alternatively, if the sonar subsystem 216 is indicating movement of the desk surface 208 but the accelerometer 214 is indicating that no movement of the desk surface is occurring, this could be interpreted as the user sliding some object under the desk surface 208. Thus, any signals from the sonar subsystem 216 which indicate movement of the desk surface is occurring, while the accelerometer is at the same time indicating that the desk surface 208 is stationary, may be understood as some external item being moved or otherwise positioned under the desk surface 208. The pressure sensitive mat 219, on which the user would be standing or seated in a chair, could also be used to help indicate or verify the presence of an individual in front of the work desk 206.

Referring further to FIG. 4, one or both of the photoelectric sensor subsystems 218a and 218b could optionally be incorporated to further provide signals which indicate if some external item (box, briefcase, laptop case, backpack, etc.) has been placed under the desk surface 208 in a position that would interfere with proper sensing by the sonar subsystem 216. Each of the photoelectric sensor subsystems 218a and 218b includes an optical transmitting element 218a1 and 218b1, respectively, and an optical receiving element 218a2 and 218b2, respectively. Sensor elements 218a1/218a2 may be located just below the desk surface 208, while sensor elements 218b1/218b2 are located just above a floor surface. If the signals from either photoelectric sensor element pair 218a1/218a2 or 218b1/218b2 indicate a blockage, this information could be used together with the signals from the sonar subsystem 216 to determine if the real time signals from the sonar subsystem are in fact accurately indicating the real time height of the desk surface 208. For example, if someone sets a box with a flat upper surface directly under the sonar subsystem 216, at least a small chance exists that the signal output from the sonar subsystem may indicate an erroneous height of the desk surface 208. A small box that reflects only a minor portion of the acoustic waves generated by the sonar subsystem may generate a signal which appears spurious or noisy (i.e., not linear as would be expected from a valid sensor reading from the sonar subsystem 216), and thus the spurious or noisy signal, by itself, may be sufficient to detect that some form of item is interfering with proper height detection by the sonar subsystem 216. In either event, the sensor signal interpretation algorithms 226 would be used to analyze the signals from the sonar subsystem 216, and if needed, would also use information from the accelerometer and/or the photoelectric sensors 218a/218b to determine if some obstacle is present which is interfering with proper sensing of the height of the desk surface 208.

As another example, the sensor signal interpretation algorithms 226 could be constructed to look at whether the desk surface 208 height has changed at the moment that a signal from the sonar subsystem 216 changed or became spurious in nature. If no movement of the desk surface 208 height has occurred, but the sonar subsystem 216 has suddenly begun indicating a different height or has suddenly began producing a spurious signal (i.e., a signal outside a normal operating range or noisy in nature to the degree of being indeterminable), then this collection of circumstances could be reasonably assumed to indicate that the user has suddenly slid some object (backpack, box, etc.) under the desk surface 208 and blocked the sonar subsystem 216. Still further, an instantaneous rate of change of the sonar signal, as analyzed using the sensor signal interpretation algorithms 226, from a first level to a second level, which would be greater or less than a rate of movement of the desk surface 208 produced by a motor associated with the desk surface 208, could also indicate that the received signals from the sonar subsystem 216 are indicating that something has been quickly slid under the desk surface 208 by the user.

The sensor signal detection algorithms 226 will of course depend on the types of sensor subsystems being used, and the extent to which one wishes to be able to determine exactly what type of abnormal condition is present. While it is expected that the use of the accelerometer 214 and the sonar subsystem 216 will cooperatively be able to detect the great majority of abnormal conditions, the use of one or more other ones of the sensor subsystems 210, 212, 218 and 219 may help to even further verify or explain the signals being collected from the sonar subsystem 216.

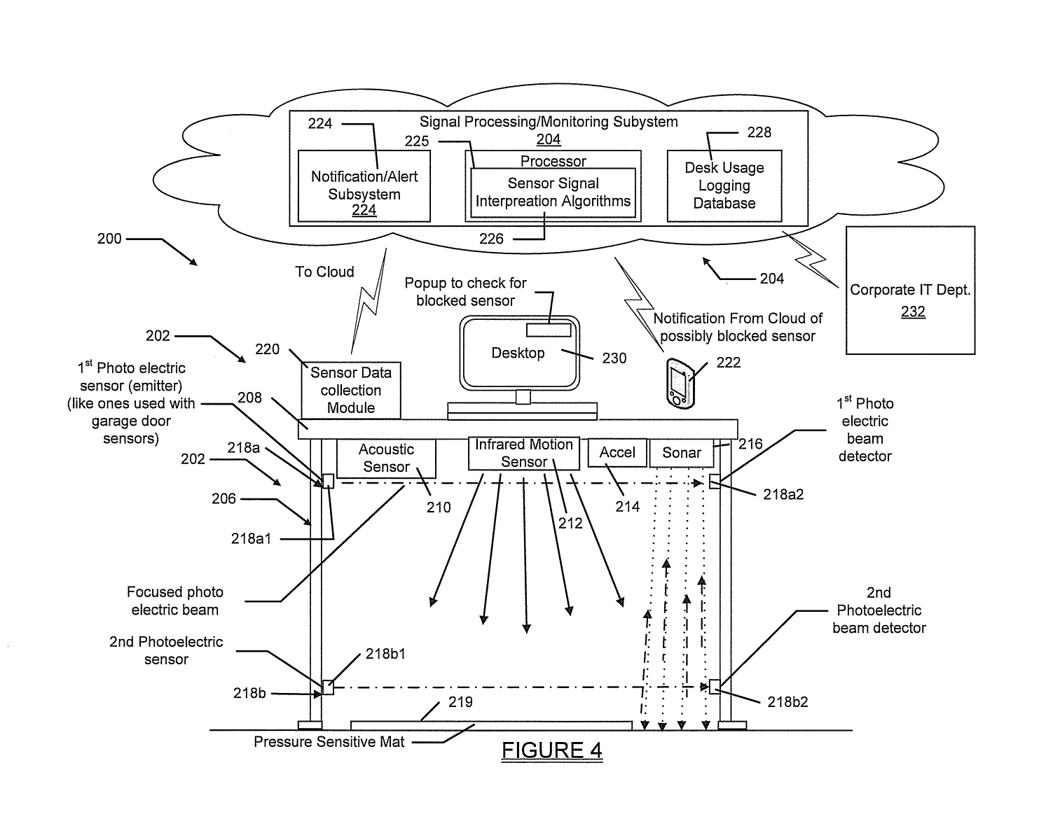

Referring to FIG. 5, a waveform is shown to illustrate various conditions that the sonar subsystem 216 can be used to detect. As noted previously, the sonar subsystem 216 may emit acoustic pulses at a predetermined frequency and for a predetermined duration. The frequency of the pulses may vary to best a specific sonar sensing subsystem being used. Dashed line 250 indicates a signal magnitude in accordance with a predetermined maximum height of the desk surface 208, and dashed line 252 indicates a signal magnitude in accordance with a predetermined minimum height of the desk surface 208. Thus, any signals that fall within these two limits may be presumed to represent a valid height of the desk surface 208, as long as the signals are “clean” signals, as will be explained further below.

The waveform pulses 254 may be viewed as “clean” pulses because they have a consistent pulse profile (e.g., in this example a good square wave profile), and they indicate the desk surface 208 being at its predetermined upper height limit. In practice, a long string of pulses 254 would typically be present while the desk surface is stationary at its maximum height, since the pulses are being obtained preferably every 10-500 ms. But for explanation purposes, only two pulses 254 have been are shown.

Waveform pulse 256 represents what a pulse may look like which is indicating that the desk surface 208 is at some intermediate height between its maximum and minimum heights. Waveform pulses 258 represent what the pulses would look like if the desk surface 208 is at its minimum height. Waveform pulse 260 represents what a pulse may look like which is obtained while the desk surface 208 is in motion being raised at a uniform, known rate of speed, such as by an electric stepper motor. In this instance, the signal processing system 204 uses the sensor signal interpretation algorithms 226 to recognize that the desk surface 208 is being raised. Waveform pulse 262 represents the desk surface 208 back at its maximum height with a clean pulse wave. Waveform pulse 264 indicates a possible spurious signal condition because the signal magnitude indicated by the pulse is below the minimum height level of the desk surface 208. Thus, one or more successive pulses such as pulse 264 may be interpreted by the sensor signal interpretation algorithms 226 as indicating that some external item (e.g., backpack, box, etc.) is under the desk surface 208 and interfering with proper sensing by the sonar subsystem 216. Waveform pulse 266 also indicates an error condition because the magnitude of the pulse is above the upper predetermined height limit of the desk surface 208 (i.e., relative to the ground). The sensor signal algorithms 226 would interpret this as some type of error condition. Waveform pulse 268 may or may not represent an error condition. The slope of the waveform pulse 268 on its leading edge indicates a rate of change of the desk surface 208 height which is noticeably greater than that seen with the waveform pulse 260. If the desk surface 208 is raised by an electric motor, then the algorithms 226 may determine that the desk surface is being raised faster than what is possible by the electric motor, and thus interpret this condition as an error condition (possibly due to the individual sliding some object under the desk surface 208). Thus, even though the waveform pulse 268 reaches a point which is within the acceptable range (i.e., at its upper limit), the greater than normal rate of change is interpreted by the algorithm 226 as a potential error condition that might be producing an erroneous desk height measurement.

With any of the waveform pulses 264, 266 or 268, the signal processing/monitoring subsystem 204 may use the notification/alert subsystem 224 to send a notification to the user, either to the user's PED 222 or to the computer system 230 in the form of an email or popup, that a situation likely exists where the sonar subsystem 216, or some other sensor subsystem, is potentially blocked by an extraneous item. Upon receiving this message, the user can take the opportunity to double check to make sure that no external objects are blocking sonar subsystem 216 sensing path.

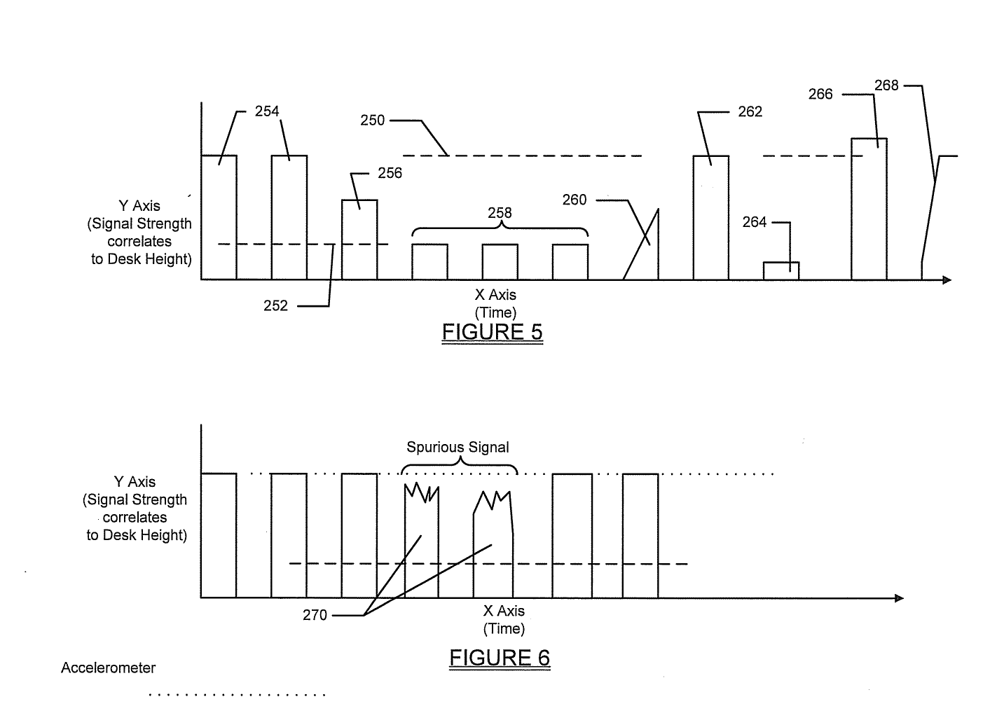

FIG. 6 illustrates waveform pulses 270 that have spurious characteristics (i.e., they do not have clean signal components), and thus are interpreted as representing some type of error condition. In this instance, there may be some rapid but intermittent blocking of the sonar subsystem 216 occurring, possibly due to someone moving objects around under the desk surface 208 or momentarily accessing a power outlet under the desk surface 208, which intermittently obstructs the transmission path of the sonar subsystem. This could be confirmed by looking at the dotted line, which represents the accelerometer 214 output. Since the accelerometer 214 output is unchanged during the two pulses 270, this provides further evidence to the system 200 that the desk surface 208 is actually not moving. And it should also be noted that although the magnitudes of the pulses 270 may be within the predetermined upper and lower limits, the pulses 270, if they continued as shown for a preset time period (e.g., more than 10 seconds), such a condition would result in a notification being sent by the notification/alert subsystem 224 that some possible blockage has occurred relative to the sonar subsystem 216. The specific signal sent to the user's PED 222 or the computer system 230 may be specific as to a certain sensor (e.g., the sonar subsystem 216), and may thus instruct the user exactly where to look for a potential blockage (e.g., a message that reads: “Please Check Under Right Side of Desk for Objects Blocking the Sonar Sensor”) or it may simply indicate to the user to make a check for blockages of any of the sensors.

It will be appreciated that the example waveform pulses shown in FIGS. 5 and 6 may vary considerably in shape depending on multiple factors, such as the precise type of sonar subsystem 216 being used. The waveform pulses shown are intended to only be examples of how various characteristics of the waveform pulses can be used by the sensor signal interpretation algorithms 226 to identify various conditions that may indicate a blocked sensor. The quick and reliable detection of those conditions potentially representing a blocked sensor condition, can ensure that the data collected by the system 200 is valid and accurate. The various sensor signals described herein can also be used to reliably detect when a user is physically present in front of the work desk system 202, thus ensuring the accuracy and validity of the collected usage data for the desk system.

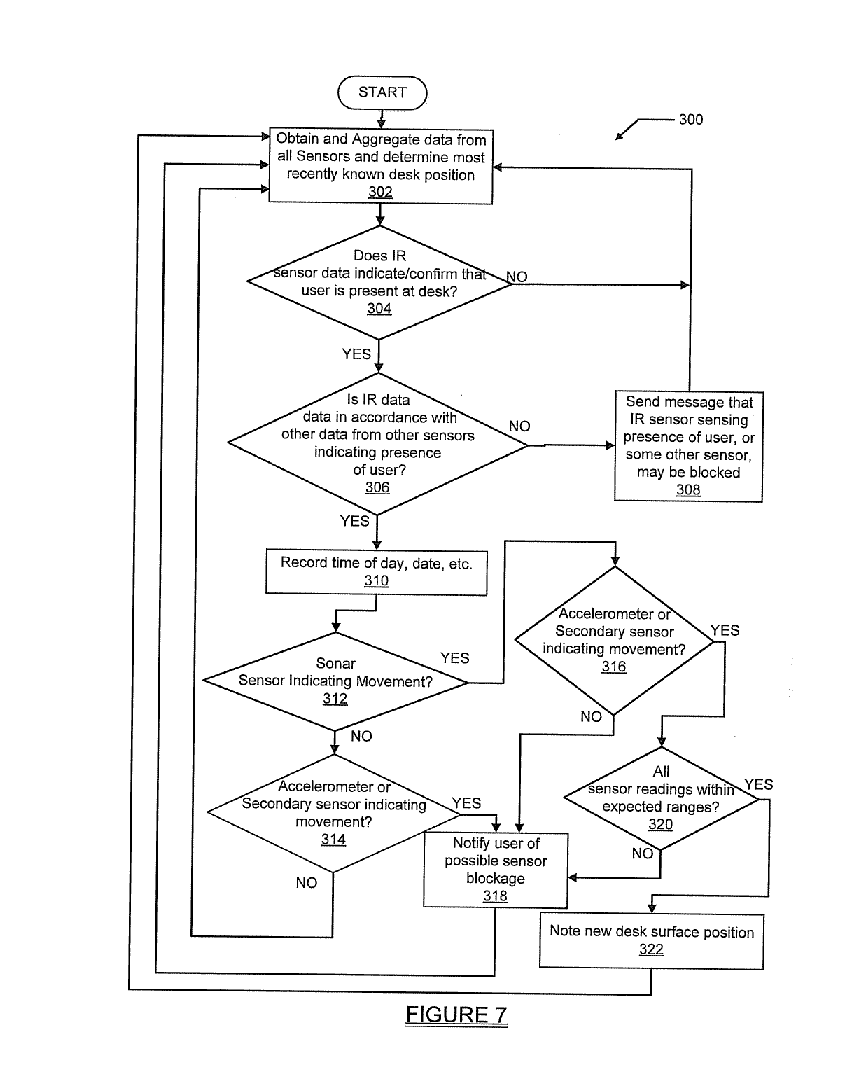

Referring to FIG. 7, a flowchart 300 is shown to illustrate one example of how the system 200 uses the various sensor subsystems 210-219 to reliably detect that an individual is present at the work desk 206, and whether or not one or more sensors may be blocked. Initially at operation 302, the system 200 obtains and aggregates data from some or, more preferably, all of the sensors 210-219, and uses this information to determine the most recently known desk surface 208 position. The most recently known desk surface 208 position will in most instances be the position the desk surface of the work desk 206 is presently at. At operation 304 the signal processing/monitoring subsystem 204 determines if the data from the infrared motion sensor 212 confirms that the user is present at the work desk 206. If not, then operation 302 is repeated. If the answer at operation 304 is “Yes”, then a check is made to determine if the data from the infrared motion sensor 212 is in accordance with other data from other ones of the sensor subsystems 210 and 214-219 (i.e., acting as “secondary” sensor systems). By “in accordance” it is meant whether the data from the infrared motion sensor 212 conflicts with any other sensor data, to thus give rise to an uncertainty as to whether the user is actually present at the work desk 206. If the answer to this inquiry is “No”, meaning that a conflict of data exists giving rise to a situation where one or more of the sensors 210-219 may be blocked, then at operation 308 a message may be sent to the user's PED 222 or the computer system 230 by the signal processing/monitoring subsystem 204 that one or more of the sensors may be blocked and to check for blockages. However, if the check at operation 306 produces a “Yes” answer, then at operation 310 the system 200 may record the time of day, date, and any other pertinent information that an entity would like to collect concerning usage of the work desk 206 by an individual.

At operation 312 the signal processing/monitoring subsystem 204 uses the data obtained from the sonar subsystem 216 to determine if the data is indicating movement of the desk surface 208. If the answer to this inquiry is “NO”, then at operation 314 the data from the accelerometer 214 (or any other secondary sensor able to detect motion of the desk surface 208) is checked to determine if the data is indicating movement of the desk surface 208. If the answer to this inquiry is “No”, then operation 302 is repeated.

If the check at operation 312 reveals that the sonar subsystem 216 data is indicating that the desk surface 208 is moving, then at operation 316 the collected accelerometer 214 data is checked to determine if the accelerometer (or some other secondary sensor) is indicating that the desk surface 208 is moving. If the answer to this inquiry is “No”, then this indicates a condition where some external object may be interfering with the sensing being performed by the sonar subsystem 216. At operation 318, the signal processing/monitoring subsystem 204 then sends a message to the user to notify the user of a possible sensor blockage condition.

If the check at operation 316 produces a “Yes” answer, indicating that the data from the accelerometer 214 or some other secondary sensor is indicating movement of the desk surface 208, then a check is made at operation 320 to determine if all of the sensor readings are within the expected ranges. If the check at operation 320 produces a “No” answer, then this indicates that some other secondary sensor data is not within a normal range. In that event a signal is sent by the signal processing/monitoring subsystem 204 to the user to notify the user of a possible sensor blockage condition, as indicated at operation 318. If the check at operation 320 indicates that the other secondary sensor data is/are all within an expected range(s), then the new desk surface 208 position is noted at operation 322 (i.e., recorded by the signal processing/monitoring subsystem 204), and operation 302 is repeated. Again, it will be appreciated that the operations and checks performed in FIG. 7 are carried out in real time using sensor data collected in real time.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A system for monitoring use of a work structure at which a user is present, and detecting if any one of one or more sensors of the system are obstructed, the system comprising:
a work structure at which a user may perform a task;
a first sensor for detecting a first characteristic of use of the work structure and generating a first signal in accordance therewith;
a second sensor for detecting a second characteristic of use of the work structure and generating a second signal in accordance therewith; and
a computer based processing and monitoring subsystem for analyzing the first and second signals and determining if one or the other of the first and second sensors is at least one of obstructed or malfunctioning.

2. The system of claim 1, wherein the first sensor is an accelerometer that measures a speed of movement of a portion of the work structure.

3. The system of claim 1, wherein the processing subsystem analyzes the first signal from the first sensor to determine if the first signal is outside of a predetermined acceptable range, thus indicating a possibility that an object is obstructing the first sensor.

4. The system of claim 1, wherein the second sensor is a sonar subsystem that detects movement of a portion of the work structure.

5. The system of claim 1, wherein:
the first sensor includes an accelerometer that measures a speed of movement of a portion of the work structure;
the second sensor includes a sonar subsystem that helps to provide an indication, via the second signal, that the portion of the work structure is moving; and
wherein the processing and monitoring subsystem uses the first and second signals to detect if either:
the portion of the work structure is moving; or
one of the first and second sensors is indicating that the portion is moving while the other one of the first and second sensors is indicating that no movement is occurring, thus indicating that one of the first or second sensors may be obstructed or malfunctioning.

6. The system of claim 1, wherein one of the first or second sensors comprises a pressure sensitive mat that detects a presence of an item placed thereon.

7. The system of claim 1, further comprising an acoustic sensor for detecting sounds emanating from an area in an immediate vicinity of the work structure, for assisting in detecting if an individual is present at the work structure.

8. The system of claim 1, further comprising a photoelectric sensor located at the work structure for assisting in detecting if an object has been placed adjacent the work structure which obstructs operation of one of the other of the first or second sensors.

9. The system of claim 1, wherein the processing and monitoring subsystem comprises a notification and alerting subsystem for generating a signal receivable by a personal electronic device of a user present at the work structure, notifying the user that at least one of the first and second sensors is at least one of potentially obstructed or malfunctioning.

10. The system of claim 1, wherein the processing and monitoring subsystem comprises a usage logging database for collecting information on usage of the work structure and providing usage information to a remotely located entity.

11. The system of claim 1, further comprising an infrared motion sensor for providing a signal to the processing subsystem indicative of whether a user is present at the work structure.

12. The system of claim 1, further comprising a sensor data collection module for receiving signals from the first and second sensors and wirelessly transmitting data information relating thereto to the processing and monitoring subsystem.

13. The system of claim 1, wherein:
the work structure comprises a work desk having an elevationally positionable desk surface;
the first sensor includes an accelerometer that measures a speed of movement of a portion of the desk surface;
the second sensor includes a sonar subsystem that helps to provide an indication, via the second signal, that the desk surface is moving; and
wherein the processing subsystem uses the first and second signals to detect if either:
the desk surface of the work structure is moving; or
one of the first and second sensors is indicating that the desk surface is moving while the other one of the first and second sensors is indicating that no movement is occurring, thus indicating that one of the first or second sensors may be obstructed or malfunctioning.

14. The system of claim 13, further comprising at least one of:
a third sensor comprising a pressure sensitive mat which provides a signal to the processing subsystem indicative of a presence or absence of an individual at the work desk;
an acoustic sensor for providing a signal to the processing subsystem of noise in an immediate vicinity of the work desk, said noise being indicative of an individual working at the work desk; and
an infrared motion sensor for sensing movement of an individual present at the work desk, and thus indicating a presence or absence of an individual at the work desk.

15. A work desk at which a user may perform work in at least one of a standing or seated orientation, the work desk comprising:
an elevationally positionable desk surface;
a first sensor for detecting a first characteristic of use of the work desk associated with movement of the desk surface and generating a first signal in accordance therewith;
a second sensor for detecting a second characteristic of use of the work structure associated with movement of the desk surface, and generating a second signal in accordance therewith; and
a computer based processing and monitoring subsystem for analyzing the first and second signals and determining if one or the other of the first and second sensors is at least one of obstructed or malfunctioning.

16. The work desk of claim 15, further comprising a third sensor for sensing a presence of a user at the work desk.

17. The work desk of claim 16, wherein the third sensor comprises one of:
an acoustic sensor; or
an infrared motion sensor.

18. The work desk of claim 17, further comprising a third sensor for detecting when an object has been placed in a line of sight path of at least one of the first or second sensors, and thus providing a signal indicative that an obstruction of one of the first or second sensors is occurring.

19. The work desk of claim 15, wherein the processing and monitoring subsystem comprises a remotely located subsystem which wirelessly receives information relating to the first and second signals.

20. A method for monitoring use of a work structure at which a user is present, and detecting if any one of one or more sensors of associated with the work structure are obstructed, the method comprising:
providing a work structure at which a user may perform a task;
using a first sensor for detecting a first characteristic of use of the work structure and generating a first signal in accordance therewith;
using a second sensor for detecting a second characteristic of use of the work structure and generating a second signal in accordance therewith; and
using a computer based processing and monitoring subsystem for analyzing the first and second signals and determining if one or the other of the first and second sensors is at least one of obstructed or malfunctioning.
